(19) United States
(12) Patent Application Publication
(10) Pub. No.: US 2019/0037035 A1
(43) Pub. Date: Jan. 31, 2019

(54) Distributed Automated Learning of User Personalization

(71) Applicant: MICROSOFT TECHNOLOGY LICENSING, LLC, Redmond, WA (US)

(72) Inventors: Akhilesh KAZA, Sammamish, WA (US); Roland RADTKE, Seattle, WA (US); Reed TOWNSEND, Kirkland, WA (US); Koushik PERI, Bellevue, WA (US)

(21) Appl. No.: 15/665,150

(22) Filed: Jul. 31, 2017

(51) Int. Cl. H04L 29/08

(52) U.S. Cl. CPC H04L 67/22; H04L 67/306

(57) ABSTRACT

Systems and methods for identifying personal signals of a target person are presented. More particularly, content is captured and or monitored on a local computing device of the target person. Personal signals of the target person are identified and a comparison to personal signals in a personal profile record of the target person is made to identify a delta of personal signals representing those signals that are not included in the personal profile record. The delta of personal signals is uploaded to a remotely located personal assistance service where they may be added to the personal profile record of the target person and the updated personal profile record of the target person is returned to the local computing device.

### BACKGROUND

Personalizing a person's computer experience to that particular person is a growing area of interest and development. This personalization is especially significant in regard to digital assistant services, such as Microsoft's Cortana or Apple's Siri, that attempt to customized, even anticipatory online services to the corresponding person/computer user.

Currently, when it comes to “learning” about the person, this processing occurs on computer systems that reside “in the cloud,” i.e., on remotely located computer systems operating to learn information about the person. In short, the person's various computing devices, e.g., smart phone, smart watch, tablet computer, laptop computer, desktop computer, etc. simply capture and forward information about the person to the learning service where the information is processed and used to update a personal profile corresponding to the person. Additionally, when it comes to providing a personalized service, the request for a service (or the triggering information that may cause anticipatory services to be provided) is captured and forwarded to the cloud services where the request is process in view of the person's profile, and the service rendered—sometimes transmitting data back to a computing device relating to the person. In short, the digital assistant service resides and operates “in the cloud”, and the person's various devices are merely capture and delivery devices.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to various systems and methods for identifying personal signals of a target person are presented. More particularly, content is captured and or monitored on a local computing device of the target person. Personal signals of the target person are identified and a comparison to personal signals in a personal profile record of the target person is made to identify a delta of personal signals representing those signals that are not included in the personal profile record. The delta of personal signals is uploaded to a remotely located personal assistance service where they may be added to the personal profile record of the target person and the updated personal profile record of the target person is returned to the local computing device.

According to additional aspects of the disclosed subject matter, a method for providing personal digital assistance to a target person is provided. The method includes obtaining a personal profile record corresponding to the target person, where the personal profile record comprises a set of personal signals corresponding to the target person. Additionally, content and/or data is captured, the content relating to the target person. A plurality of personal signals of the target person are then identified from the captured content and a delta of personal signals is determined between the set of personal signals of the personal profile record and the identified plurality of personal signals. The delta comprises one or more personal signals of the target person that are not within the set of personal signals of the personal profile record. Thereafter, the delta of personal signals is submitted over a network to a remotely located personal assistance service that is operating remotely to the personal computing device of the target person. Further still, an updated personal profile record corresponding to the target person is obtained from the personal assistance service, the updated personal profile record including an updated set of personal signals that includes at least one personal signal of the delta of personal signals.

According to further aspects of the disclosed subject matter, a local computing device of a target person is provided. The local computing device is configured to provide personal assistance services for the target person. The computing device comprises a processor and a memory, wherein the processor executes instructions as part of or in conjunction with additional executable components to provide the personal assistance services, the additional components comprising a content and data capture component, a personal signal identification component, and a local personal assistance module. In execution, the content and data capture component captures content relating to the target person in an ongoing manner. The personal signal identification component, in execution, identifies a plurality of personal signals of the target person from captured content and determines a delta of personal signals between a set of personal signals of a personal profile record and the identified plurality of personal signals. This delta comprises one or more personal signals of the target person that are not within the set of personal signals of the personal profile record. The personal signal identification component further submits the delta of personal signals over a network to a remotely located personal assistance service that is operating remotely to the local computing device. Further, the personal signal identification component obtains an updated personal profile record of the target person from the remotely located personal assistance service, where the updated personal profile record including an updated set of personal signals that includes at least one personal signal of the delta of personal signals. The local personal assistance module, in execution on the local computing device, communicates with the remotely located personal assistance service to provide personal assistance services according to the personal signals of the target person.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a block diagram illustrating an exemplary network environment suitable for implementing aspects of the disclosed subject matter;

FIG. 2 is a flow diagram illustrating an exemplary routine, as implemented by a person's computing device, suitable for capturing personal signals in accordance with aspects of the disclosed subject matter;

FIG. 3 is a flow diagram illustrating an exemplary routine, as implemented by the remote personal assistance service, to process a delta record containing personal signals not already in the person's personal profile record;

FIG. 4 is a block diagram illustrating an exemplary computer readable medium suitable for bearing executable instructions that implement aspects of the disclosed subject matter;

FIG. 5 is a block diagram illustrating an exemplary personal computing device suitable for capturing personal signals of the corresponding person/computer user in accordance with aspects of the disclosed subject matter; and

FIG. 6 is a block diagram illustrating an exemplary server computer suitably configured to implement aspects of the disclosed subject matter.

### DETAILED DESCRIPTION

In contrast to the typical system in which all processing and learning occurs by a service that operates in the cloud, according to various embodiments of the disclosed subject matter the various personal computing devices of a person/device user are utilized to capture personal signals of the person. Moreover, in capturing personal signals, the various personal computing devices determine a delta of information between known personal information (as evidenced in a personal profile record) and information that is newly gathered or identified, in order to minimize the information that transmitted to an “in the cloud” service for processing as well as protect that content from the risk of exposure to others. At the server level, after processing the “new” personal signals of the person and incorporating them into the personal profile record corresponding to the user, the updated personal profile record of the person is provided back to the various personal computing devices of the person. As will be readily appreciated, because only newly identified personal signals are communicated with the online personalization service, a substantial reduction in communication bandwidth is realized.

In addition to reduced transmission traffic through limiting the transmission of data to newly identified personal signals and receiving updated personal profile records, as personal signals are identified by the various personal computing devices of the person, the bases on which these personal signals is identified is maintained at the local level and not transmitted to the online service. This results in multiple technical benefits. A first benefit, of course, is that the content/bases of the various personal signals is not transmitted to the online service thus reducing bandwidth requirements. While the actual content bases from which a personal signal may be large, the identified personal signal may be reduced to a small record or token (e.g., according to some established ontology), thereby further reducing the amount of network traffic needed to exchange the information. A second benefit is in the realm of personal security: the content/basis from which a new personal signal is derived is not transmitted to a remote service that may be subjected to unwanted hacking, thereby exposing potentially sensitive material to others. Utilizing the aspects of the disclosed subject matter, that content which will now result in any newly identified personal signal is not transmitted to the online service. This realizes both significant gains in reduced resource utilization, as well as significant gains in protecting potentially sensitive, personal information.

An additional advantage of the disclosed subject matter results from sharing a personal profile record across the multiple computing devices of the person. For example, information regarding a person's fingerprint (e.g., for authentication purposes) that is captured in a personal profile record can be shared across multiple devices without causing the additional devices to be specifically trained about the fingerprint. Similarly, passwords established in a first computing device can be shared across each of a person's personal computing devices, or utilized when the person authenticates on a new or shared computing device. Indeed, a digital assistant service operating on a shared computing device (such as a shared desktop computer), could obtain a personal profile record of the person (after authentication on the shared device) and, for as long as that person remains logged into that computing device, provide personalized assistance without the need to be trained over time.

Yet another advantage of the disclosed subject matter arises from the fact that many computer users have and utilize multiple computing devices. It is not uncommon for a person to have a smart phone, a tablet computer, and a desktop and/or laptop computer. In addition to sharing a personal profile record for that person across these multiple computing devices to provide consistent, personalized services, these computing devices can be further federated in a manner to cooperatively capture and/or identify the various personal signals of the person. For example, those personal computing devices that have limited processing capabilities, e.g., a smart watch or other wearable device, may be configured to share current content and data with the person's other computing devices, some of which may be configured to process the captured content and data from the less capable device for identifying new personal signals. Moreover, these same computing devices (that have more processing capabilities) may also be configured to periodically (or at some predetermined interval or event) upload the newly identified signals to the online service, relieving this burden from the less capable devices, and the distribute updated personal profile records to the federated computing devices.

For purposes of clarity and definition, the term “exemplary,” as used in this document, should be interpreted as serving as an illustration or example of something, and it should not be interpreted as an ideal or leading illustration of that thing. Stylistically, when a word or term is followed by “(s)”, the meaning should be interpreted as indicating the singular or the plural form of the word or term, depending on whether there is one instance of the term/item or whether there is one or multiple instances of the term/item. For example, the term “user(s)” should be interpreted as one or more users. Moreover, the use of the combination “and/or” with regard to multiple items should be viewed as meaning either or both items.

By way of definition and clarity, a digital assistant service is an executable/executing service that is configured to provide personalized assistance to a person/computer user. Personalized assistance is some action or activity, as carried out on a computing device for the benefit or on behalf of the person.

By way of definition and clarity, a personal signal corresponds to some aspect of information that relates to a particular person. Various items of demographic information, such as (by way of illustration and not limitation) gender, nationality, race, marital status, and age may each correspond to a personal signal regarding the person. Of course, other person-related aspects, other than demographic information, may be identified as a personal signal. By way of illustration and not limitation, a personal signal may correspond to education, employment, residence and/or citizenship, spoken languages, height, weight, whether the person is left- or right-handed or ambidextrous, frequent words and phrases used by the person, social and employment contacts, hobbies, expertise, current location, locations visited, and the like. Indeed, personal signals include those elements that define who we are. A personal signal need not be unique to the person but the collective set of personal signals (including those recorded in a personal profile record for that person) are often unique to that person.

Regarding the personal profile record and by way of definition, a personal profile record comprises, at least, a collection of personal signals of the corresponding person. Other information, such as identifying information and the like, may also be included in a personal profile record.

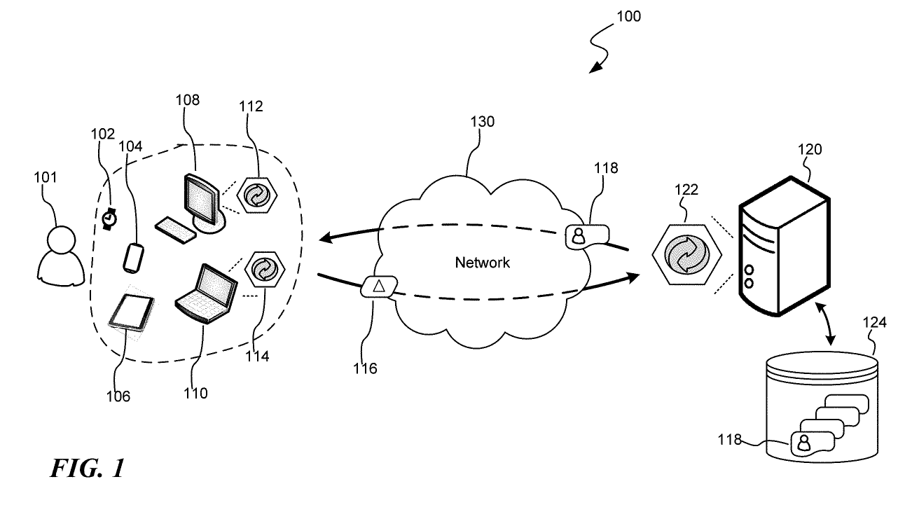

Turning to the figures, FIG. 1 is a block diagram illustrating an exemplary network environment 100 suitable for implementing aspects of the disclosed subject matter. More particularly, FIG. 1 illustrates an exemplary network 100 in which automated, distributed discovery and learning of user personalization may occur. As suggested above, by distributing the identification and aggregation of personal signals between personal computing devices and a remote digital assistance service, significant improvements in reduced bandwidth usage and improved security of sensitive, personal identifying information (PII) are achieved.

As indicated above, a person will typically have one or more computing devices that he/she may use. For illustration purposes, the person/computer user 101 has several computing devices that are utilized, including a smart watch 102, a mobile phone 104, a tablet computer 106, a laptop computer 110 and desktop computer 108. Each of these devices, to some extent as may be determined according to the processing capacity of the respective computing device, may be configured to provide personalized digital assistance to the person 101. More particularly, each of these computing devices may be configured to implement a digital assistance service, such as digital assistance services 112 and 114 operating on computing devices 108 and 110 respectively. As part of providing digital assistance, learning about the corresponding person 101 is important. As part of the configuration to provide digital assistance to the person, these devices are configured to monitor and/or capture data and content relating to the person, analyze the data and content, and identify personal signals relating to the person.

According to aspects of the disclosed subject matter, the person's various computing devices may be federated in such a manner that more capable computing devices may be designated for processing and analysis of monitored and/or captured data and content to identify personal signals, as well as identify those personal signals that have not been previously identified as being associated with the person. These federated devices can communicate over a variety of communication media including, by way of illustration and not limitation, wired connections, local-area networks, near-field communications (NFC), Bluetooth, etc. to communicate and exchange data among the various computing devices.

According to aspects of the disclosed subject matter, one or more computing devices associated with the person compare the identified personal signals against personal signals that have been previously identified, typically encapsulated in a personal profile record, in an effort to identify those personal signals that are new, i.e., not previously captured within the person's personal profile record. These identified personal signals (not recorded in the personal profile record) are viewed as delta information or, more simply, the delta.

Once the delta of personal signals is identified, a delta record 116 containing that information is transmitted over a network 130 to a personal assistance service 122 operating “in the cloud” on a network computing device (or devices) 120. The personal assistance service maintains a data store 124 of personal profile records, such as personal profile record 126, for a plurality of persons/computer users including person 101. According to various aspects of the disclosed subject matter, the delta record of new personal signals may be transmitted in such a manner as to preserve the privacy of the person. For example, by way of illustration and not limitation, data encryption may be used when transmitting the information between the remote personal assistance service 122 and one of the person's computing devices. Alternatively, the delta record 116 may include encoded data (though not encrypted) that is understood by the remote service, e.g., local processing, transformations, and/or calculations to reduce the information to data that makes sense to the service but not to others that may try to intercept the data. Generally speaking, efforts may be taken to ensure that the data exchanged between a remote personal assistance service 122 and local computing devices is obscured such that personal information about the person is not revealed even when the communications may be intercepted.

The personal assistance service 122 obtains the delta record 116 and, based on the information in the delta record, updates the personal profile record 118 of the person 101. The updated personal profile record 118 is then transmitted to the various computing devices of the person 101. In one embodiment, the personal profile record 118 is transmitted to one of the various computing devices of the person 101, such as computing device 108, which in turn distributes the updated personal profile record 118 (or portions of the record) to the rest of the person's computing devices.

According to aspects of the disclosed subject matter, the process of generating a delta record 116, uploading the delta record to the personal assistance service 122, and receiving an updated personal profile record 118 may be conducted in an on-demand manner, on the occurrence of a triggering event, in a periodic manner (such as once daily, or at fixed times during the day, etc.), or both in a periodic manner and in an on-demand manner. The times for exchanging data may be determined according to costs such that content is exchanged when transmission costs are low.

Regarding the distribution of the updated personal profile record 118, when the computing devices are federated such that they work in cooperation as described above, distribution of information of the updated personal profile record 118 may be conducted according to the processing abilities of the receiving computing device determined to be the distribution point for the person's federated computing devices. Moreover, in some instances, distribution of information may be based according to the processing abilities of the receiving computing device. For example, a smart watch 102 may not necessarily need to have personal signals that correspond to favorite web sites that are visited due to the lack of a network browser on the smart watch and, as such, only information that is applicable to the smart watch is distributed to the smart watch from a distribution device.

In yet an additional embodiment of the disclosed subject matter, in addition to cooperative distribution of information, the person's various federated computing devices may cooperate to learn about the corresponding person, i.e., use computer learning models to identify new personal signals of the person, without involving the remote personal assistance service 122. Indeed, the various personal computing devices may be configured, according to the abilities of each, to conduct machine learning techniques with regard to monitoring content relating to the person and identifying personal signals from the monitored content. For example, while a smart watch 102 may identify various actions and activities of the corresponding person, this information may be provided to a desktop computer 108 (via a local-area network (LAN), near-field communication (NFC), BlueTooth network protocols, and the like) where additional processing by the local personal assistance service 112 may identify personal signals and differentiate between known personal signals and new personal signals to create a delta record that may be used locally or in conjunction with the remotely located personal assistance service 122. Computer learning (also referred to as machine learning) may include, by way of illustration and not limitation, techniques, algorithms and/or heuristics in recognizing patterns, correlations, similarities, frequencies, emphasis, static analyses of content, classifications, regression analyses, clustering and density analyses, and the like.

In addition to simply federating computing devices for identification of personal signals, in various embodiments (not shown) one or more local personal assistance services, such as local personal assistance services 112 and 114, may fully implement the services of the remote personal assistance service 122. In particular, one or more local personal assistance services may maintain or host its own data store 124 and maintain the personal profile record 118 locally. Of course, this configuration further enhances the security of the personal information contained within the personal profile record 118 as the information is not stored by a third party, reducing the likelihood of exposure to malicious attacks.

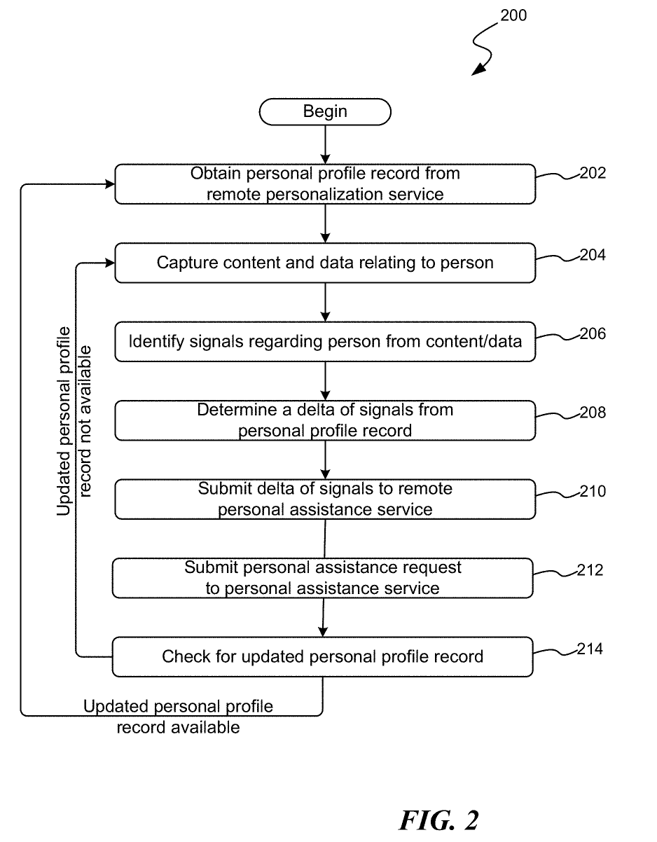

Turning now to FIG. 2, FIG. 2 is a flow diagram illustrating an exemplary routine 200 suitable for capturing personal signals in accordance with aspects of the disclosed subject matter. More particularly, at block 202, a personal profile record, such as personal profile record 118, is obtained from a remote personal assistance service 122. As discussed above, obtaining the personal profile record from the personal assistance service may be made by way of a federated computing device of the person.

At block 204, content and data relating to the corresponding person is captured (or identified). Capturing (or identifying) content and/or data relating to the corresponding person may comprise (by way of illustration and not limitation) any of examining communications of the person (email, text messages, phone conversations, and the like), examining location information of the person, examining calendars and contact information of the person, examining content generated by the person, determining travel times of the person, and the like. The capturing and identification of content and data may comprise monitoring any number of data sources likely to include personal signals relating to the person.

At block 206, one or more personal signals relating the person are identified from the captured (or monitored) content and data of block 204. The identification of signals may comprise identifying interesting terms that the person has used, or contacts in conjunction with a scheduled appointment, persons calling the target person or persons called by the target person, and the like. Indeed, any number of personal signals may be identified from the captured (or monitored) content and data.

At block 208, a delta of personal signals is made, where the delta represents personal signals that are not currently part of the personal profile record 118. At block 210, the delta of personal signals is submitted to the remote personal assistance service 122 where the information is processed and, at least potentially, incorporated into the person's personal profile record 118.

At block 212, a request for personal assistance is made. This request, whether an explicit request made by the person or an anticipatory, implied request made on behalf of the person, is submitted to the personal assistance service 122. In accordance with aspects of the disclosed subject matter, the personal assistance service 122 takes an appropriate action on behalf of the person based, at least in part, on at least one of the personal signals provided in the delta of personal signals.

Of course, it should be appreciated that while the request for personal assistance is shown as being made at this particular location in routine 200, in fact any given request may be made at any point while the routine 200 is capturing or monitoring content, identifying personal signals, determining a delta of personal signals, uploading the personal signals to the personal assistance service 122, or in obtaining an updated personal profile record 118 (as described below). Accordingly, the particular location in this routine 200 of the request for personal assistance should be viewed as illustrative and not fixed.

At block 214, a check is made to determine whether there is an updated personal profile record 118 corresponding to the person. If there is, the routine 200 returns to block 202 to obtain the updated record. Alternatively, if there is no updated personal profile record available, the routine 200 returns to block 204 to continue processing.

Regarding the routine 200, the steps of capturing content and identifying signals regarding the person may continue for some predetermined period of time such that the submission of the delta information is made on a periodic basis. For example, capturing content and data, identifying personal signals within that content and data, and determining those signals that are new (i.e., not already identified in the personal profile record 118) may be carried out over a period of time while awaiting a designated time period in which the delta is submitted to the personal assistance service 122 for updating the person's personal profile record 118. Alternatively, processing may continue until a directive from the person to update is received, or until a threshold amount of new personal signals is identified thereby triggering an update. In any event, while processing of routine 200 could be terminated at some point, it is illustrated as an on-going process to continually capture additional, new personal signals corresponding to the person.

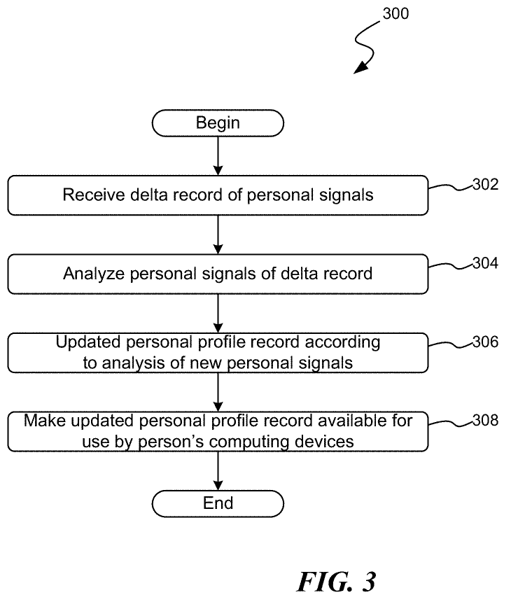

Turning to FIG. 3, FIG. 3 is a flow diagram illustrating an exemplary routine, as implemented by the remote personal assistance service, to process a delta record containing personal signals not already in the person's personal profile record. Beginning at block 302, a delta record containing “new” personal signals, i.e., personal signals that are not in the person's personal profile record 118, is received.

At block 304, an analysis of the personal signals in the delta record is conducted. This analysis is an examination of the personal signals as well as indications as to why they may be included as personal signals, and a determination as to whether and which personal signals should be included in the person's personal profile record.

At block 306, the person's personal profile record 118 is updated according to the analysis of the previous step. In other words, some of the personal signals that were identified in the delta record may be included as personal signals for the user in the personal profile record. At block 308, the person's updated personal profile record 118 is made available for access/download by the person's various computing devices. As suggested above, downloading the personal profile record may be conducted on a periodic basis, on the occurrence of a triggering event, in an on-demand manner, or some combination thereof. Alternatively, not shown, an updated personal profile record may be returned in response to executing this routine 300. Thereafter, the routine 300 terminates.

Regarding routines 200 and 300 described above, as well as other processes that may be described herein, while these routines/processes are expressed in regard to discrete steps, these steps should be viewed as being logical in nature and may or may not correspond to any specific actual and/or discrete execution steps of a given implementation. Also, the order in which these steps are presented in the various routines and processes, unless otherwise indicated, should not be construed as the only order in which the steps may be carried out. Moreover, in some instances, some of these steps may be combined and/or omitted. Those skilled in the art will recognize that the logical presentation of steps is sufficiently instructive to carry out aspects of the claimed subject matter irrespective of any particular development or coding language in which the logical instructions/steps are encoded.

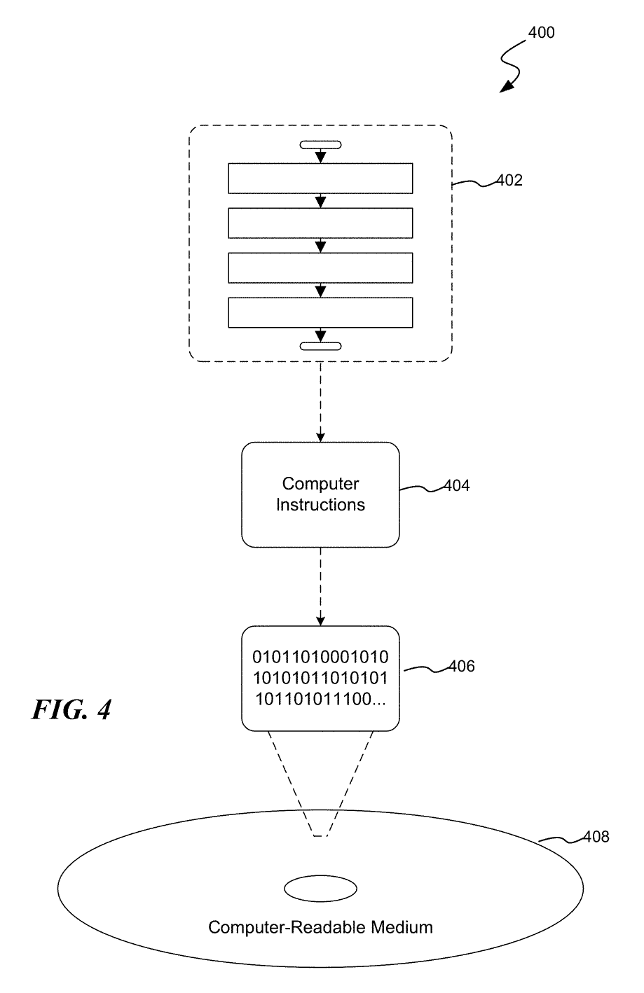

Of course, while the routines and/or processes include various novel features of the disclosed subject matter, other steps (not listed) may also be included and carried out in the execution of the subject matter set forth in these routines. Those skilled in the art will appreciate that the logical steps of these routines may be combined together or be comprised of multiple steps. Steps of the above-described routines may be carried out in parallel or in series. Often, but not exclusively, the functionality of the various routines is embodied in software (e.g., applications, system services, libraries, and the like) that is executed on one or more processors of computing devices, such as the computing device described in regard FIG. 4 below. Additionally, in various embodiments all or some of the various routines may also be embodied in executable hardware modules including, but not limited to, system on chips (SoC's), codecs, specially designed processors and or logic circuits, and the like on a computer system.

As suggested above, these routines and/or processes are typically embodied within executable code blocks and/or modules comprising routines, functions, looping structures, selectors and switches such as if-then and if-then-else statements, assignments, arithmetic computations, and the like that, in execution, configure a computing device to operate in accordance with the routines/processes. However, the exact implementation in executable statement of each of the routines is based on various implementation configurations and decisions, including programming languages, compilers, target processors, operating environments, and the linking or binding operation. Those skilled in the art will readily appreciate that the logical steps identified in these routines may be implemented in any number of ways and, thus, the logical descriptions set forth above are sufficiently enabling to achieve similar results.

While many novel aspects of the disclosed subject matter are expressed in routines embodied within applications (also referred to as computer programs), apps (small, generally single or narrow purposed applications), and/or methods, these aspects may also be embodied as computer executable instructions stored by computer readable media, also referred to as computer readable storage media, which are articles of manufacture. As those skilled in the art will recognize, computer readable media can host, store and/or reproduce computer executable instructions and data for later retrieval and/or execution. When the computer executable instructions that are hosted or stored on the computer readable storage devices are executed by a processor of a computing device, the execution thereof causes, configures and/or adapts the executing computing device to carry out various steps, methods and/or functionality, including those steps, methods, and routines described above in regard to the various illustrated routines and/or processes. Examples of computer readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random-access memory (RAM), read-only memory (ROM), memory cards, thumb drives, and the like; cloud storage (i.e., an online storage service); and the like. While computer readable media may reproduce and/or cause to deliver the computer executable instructions and data to a computing device for execution by one or more processors via various transmission means and mediums, including carrier waves and/or propagated signals, for purposes of this disclosure computer readable media expressly excludes carrier waves and/or propagated signals.

Regarding computer readable media, FIG. 4 is a block diagram illustrating an exemplary computer readable medium encoded with instructions for detecting personal signals in monitored and/or captured content and data, as described in regard to FIGS. 2 and 3. More particularly, the implementation 400 comprises a computer-readable medium 308 (e.g., a CD-R, DVD-R or a platter of a hard disk drive), on which is encoded computer-readable data 406. This computer-readable data 406 in turn comprises a set of computer instructions 404 configured to operate according to one or more of the principles set forth herein. In one such embodiment 402, the processor-executable instructions 404 may be configured to perform a method, such as at least some of exemplary methods 200 and 300, for example. In another such embodiment, the processor-executable instructions 404 may be configured to implement a system on a computing device, such as at least some of the exemplary, executable components of system 500, as described below. Many such computer readable media may be devised, by those of ordinary skill in the art, which are configured to operate in accordance with the techniques presented herein.

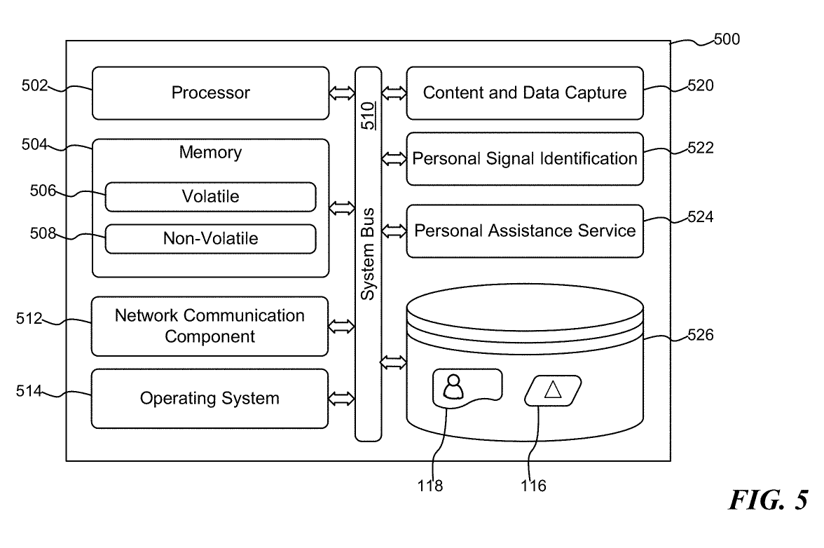

Turning now to FIG. 5, FIG. 5 is a block diagram illustrating an exemplary personal computing device 500 suitable for capturing personal signals of the corresponding person/computer user in accordance with aspects of the disclosed subject matter. As suggested above, a suitably configured personal computing device may comprise any of a number of computing devices including, by way of illustration and not limitation, a desktop computer 108, a laptop/notebook computer 110, a tablet computer 106, a mobile phone 104 and/or a smart watch 102. Generally speaking, irrespective of the particular type of computing device, the computing device 500 typically includes one or more processors (or processing units), such as processor 502, and further includes at least one memory 504. The processor 502 and memory 504, as well as other components of the computing device, are interconnected by way of a system bus 510.

As will be appreciated by those skilled in the art, the memory 504 typically (but not always) comprises both volatile memory 506 and non-volatile memory 508. Volatile memory 506 retains or stores information so long as the memory is supplied with power. In contrast, non-volatile memory 508 is capable of storing (or persisting) information even when a power supply is not available. Generally speaking, RAM and CPU cache memory are examples of volatile memory 506 whereas ROM, solid-state memory devices, memory storage devices, and/or memory cards are examples of non-volatile memory 508.

As will also appreciated by those skilled in the art, the processor 502 executes instructions retrieved from the memory 504, from computer readable media, such as computer readable media 400 of FIG. 4, and or other executable components in carrying out various functions of providing personal assistance to a person. The processor 502 may be comprised of any of a number of available processors such as single-processor, multi-processor, single-core units, and multi-core units, which are well known in the art.

Further still, the illustrated computing device 500 typically also includes a network communication component 512 for interconnecting this computing device with other devices and/or services over a computer network, such as network 130 of FIG. 1. The network communication component 512, sometimes referred to as a network interface card or NIC, communicates over a network using one or more communication protocols via a physical/tangible (e.g., wired, optical fiber, etc.) connection, a wireless connection such as WiFi or Bluetooth communication protocols, NFC, or a combination thereof. As will be readily appreciated by those skilled in the art, a network communication component, such as network communication component 512, is typically comprised of hardware and/or firmware components (and may also include or comprise executable software components) that transmit and receive digital and/or analog signals over a transmission medium (i.e., the network.)

In addition to the various component identified above, the computing device 500 further includes an operating system 514 that provide system software for the computing device, which manages both hardware and software resources of the computer. As will be appreciated by those skilled in the art, the operating system also provides a common set of services for the execution of executable modules, including applications, services, drivers, daemons, processes, and the like, on the computing device 500.

In addition to the components above, the exemplary personal computing device 500 also includes an executable content and data capture component 520. The content and data capture component 520, in execution, captures content and data (at least temporarily) such that an executable personal signal identification component 522 can identify personal signals about the person. Moreover, the personal signal identification component 522 further identifies a delta of personal signals, identifying those personal signals that are not already included in a personal profile record 118 stored in a data store 526 on (or accessible to) the computing device. Still further, a personal assistance service 524, in execution, is able to submit personal assistance requests to the remotely located personal assistance service 122, as mentioned above.

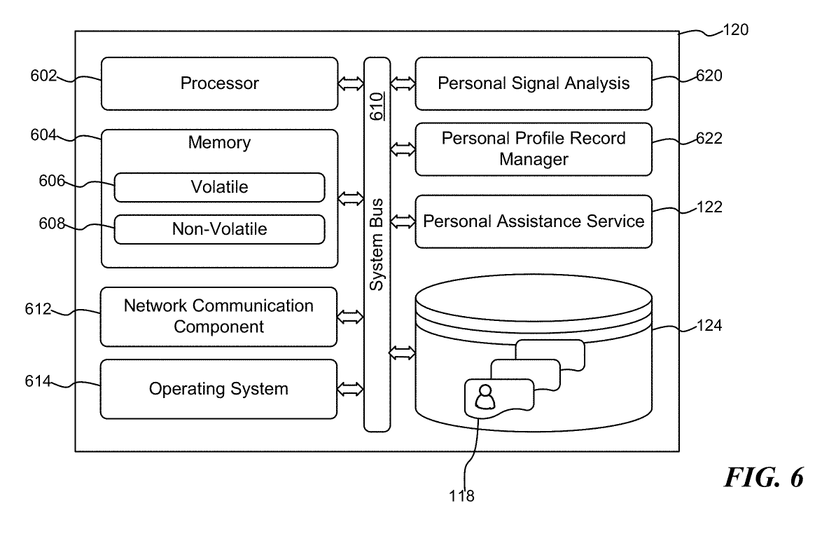

In contrast to the local, personal computing device 500 of FIG. 5, FIG. 6 is a block diagram illustrating an exemplary server computer 120 suitably configured to implement aspects of the disclosed subject matter, particularly in regard to implementing a remote personal assistance service 122. As with the personal computing device 500, the exemplary server computer 120 typically includes one or more processors (or processing units), such as processor 602, and further includes at least one memory 604. The processor 602 and memory 604, as well as other components of the computing device, are interconnected by way of a system bus 610. The memory 604 comprises at least one or both of volatile memory 606 and non-volatile memory 608.

The processor 602 executes instructions retrieved from the memory 604, from computer readable media, such as computer readable media 400 of FIG. 4, and or other executable components in carrying out various functions of providing personal assistance to a person. The processor 402 may be comprised of any of a number of available processors such as single-processor, multi-processor, single-core units, and multi-core units, which are well known in the art.

Also included in the exemplary server computer 120 is an executable personal signal analysis module 620. As discussed above in regard to routine 300 of FIG. 3, in execution this personal signal analysis module 620 analyzes the personal signals of a delta record, such as delta record 116 of FIG. 1, and determines whether the signal belongs in the personal profile record 118 of the person, as stored with the personal profile records of other persons in a data store 124 maintained for this purpose. The personal profile record manager 622 manages the requests from local computing devices for a personal profile record of a target person, and updates the personal profile records as directed by the personal signal analysis module 620. Additionally, an executable personal assistance service 122 provides personal assistance to a person in response to a request from a personal assistance module on a local computing device.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method as implemented on a personal computing device of a target person, the method comprising:
obtaining a personal profile record corresponding to the target person, the personal profile record comprises a set of personal signals corresponding to the target person;
capturing content relating to the target person;
identifying a plurality of personal signals of the target person from the captured content;
determining a delta of personal signals between the set of personal signals of the personal profile record and the identified plurality of personal signals, the delta comprising one or more personal signals of the target person that are not within the set of personal signals of the personal profile record;
submitting the delta of personal signals over a network to a remotely located personal assistance service that is operating remotely to the personal computing device of the target person; and
obtaining an updated personal profile record corresponding to the target person from the personal assistance service, the updated personal profile record including an updated set of personal signals that includes at least one personal signal of the delta of personal signals.

2. The computer-implemented method of claim 1, further comprising:
repeating the steps of capturing content, identifying a plurality of personal signals, determining a delta of personal signals, submitting the delta of personal signals, and obtaining an updated personal profile record; and
wherein each of the repeated steps utilize the updated personal profile record as the personal profile record of the target person.

3. The computer-implemented method of claim 2, wherein repeating the steps of capturing content, identifying the plurality of personal signals, determining the delta of personal signals, submitting the delta of personal signals, and obtaining the updated personal profile record is conducted on a periodic basis.

4. The computer-implemented method of claim 3, wherein the periodic basis corresponds to once a day at a time when transmission rates are low.

5. The computer-implemented method of claim 2, wherein repeating the steps of capturing content, identifying a plurality of personal signals, determining a delta of personal signals, submitting the delta of personal signals, and obtaining an updated personal profile record is conducted on the occurrence of a triggering event.

6. The computer-implemented method of claim 2, wherein repeating the steps of capturing content, identifying a plurality of personal signals, determining a delta of personal signals, submitting the delta of personal signals, and obtaining an updated personal profile record is conducted in an on-demand manner.

7. The computer-implemented method of claim 2, wherein:
the personal computing device of the target person is one of a plurality of personal computing devices of the target person, and wherein the plurality of personal computing devices of the target person are federated in regard to providing personal assistance services;
the personal computing device obtains the personal profile record corresponding to the target person from the remotely located personal assistance service and via another personal computing device of the target person; and
the personal computing device submits the delta of personal signals to the remotely located personal assistance service via the another personal computing device of the target person.

8. The computer-implemented method of claim 7, wherein:
the personal computing device identifies the plurality of personal signals of the target person from the captured content via the another personal computing device of the target person.

9. The computer-implemented method of claim 8, wherein the another personal computing device of the target person is selected according to the processing abilities of the another personal computing device.

10. A local computing device of a target person configured to provide personal assistance services, the computing device comprising a processor and a memory, wherein the processor executes instructions as part of or in conjunction with additional executable components to provide the personal assistance services, the additional components comprising:
a content and data capture component that, in execution on the local computing device, is operable to capture content relating to the target person; and
a personal signal identification component that, in execution on the local computing device, is operable to:
identify a plurality of personal signals of the target person from captured content;
determine a delta of personal signals between a set of personal signals of a personal profile record of the target person and the identified plurality of personal signals, the delta comprising one or more personal signals of the target person that are not within the set of personal signals of the personal profile record;
submit the delta of personal signals over a network to a remotely located personal assistance service that is operating remotely to the local computing device of the target person; and
obtain an updated personal profile record corresponding to the target person from the remotely located personal assistance service, the updated personal profile record including an updated set of personal signals that includes at least one personal signal of the delta of personal signals; and
a local personal assistance module that, in execution on the local computing device, communicates with the remotely located personal assistance service to provide personal assistance services according to the personal signals of the target person.

11. The local computing device of claim 10, wherein:
the personal signal identification component is further configured to repeatedly identify personal signals of the target person from the captured content, determine the delta of personal signals, submit the delta of personal signals to the remotely located personal assistance service; and obtain an updated personal profile record corresponding to the target person; and
wherein each of the repeated steps utilize the updated personal profile record as the personal profile record of the target person

12. The local computing device of claim 11, wherein repeating the identification a plurality of personal signals, determination of the delta of personal signals, submission of the delta of personal signals, and obtaining an updated personal profile record is conducted on a periodic basis.

13. The local computing device of claim 12, wherein the periodic basis corresponds to once a day at a time when transmission rates are low.

14. The local computing device of claim 11, wherein repeating the identification a plurality of personal signals, determination of the delta of personal signals, submission of the delta of personal signals, and obtaining an updated personal profile record is conducted on the occurrence of a triggering event.

15. The local computing device of claim 11, wherein repeating the identification a plurality of personal signals, determination of the delta of personal signals, submission of the delta of personal signals, and obtaining an updated personal profile record is conducted in an on-demand manner.

16. The local computing device of claim 11, wherein:
the local computing device of the target person is one of a plurality of personal computing devices of the target person, and wherein the plurality of personal computing devices of the target person are federated in regard to providing personal assistance services;
the local computing device obtains the personal profile record corresponding to the target person from the remotely located personal assistance service and via another personal computing device of the target person; and
the local computing device submits the delta of personal signals to the remotely located personal assistance service via the another personal computing device of the target person.

17. The local computing device of claim 16, wherein:
the local computing device identifies the plurality of personal signals of the target person from the captured content via the another personal computing device of the target person.

18. The local computing device of claim 17, wherein the another personal computing device of the target person is selected according to the processing abilities of the another personal computing device.

19. The local computing device of claim 17, wherein the local computing device is any one of a smart watch, a mobile phone, or a tablet computer.

20. A computer system configured to provide personal assistance services to a target person, the system comprising a processor and a memory, wherein the processor executes instructions retrieved from memory as part of or in conjunction with additional components to provide personal assistance services to the target person, the additional components comprising:
an executable personal signal analysis module that, in execution and in response to receiving a delta of personal signals from a personal computing device of the target person, analyzes which of the personal signals of the delta of personal signals should be included in a personal profile record for the target person, and updates the personal profile record of the target person with those personal signals that should be included;
an executable personal profile record manager that, in execution on the computer system, maintains a plurality of personal profile records corresponding to a plurality of persons, including the target person; and
an executable personal assistance service that, in execution on the computer system, provides personal assistance to the target person in view of one or more personal signals of the personal profile record of the target person.
